(19) United States
(12) Patent Application Publication
(10) Pub. No.: US 2004/0177850 A1
(43) Pub. Date: Sep. 16, 2004

(54) Breathing assistance apparatus

(76) Inventors: Lewis George Gradon, Auckland (NZ); Alastair Edwin McAuley, Auckland (NZ); Ivan Milivojevic, Auckland (NZ)

Correspondence Address: TREXLER, BUSHNELL, GIANGIORGI,, BLACKSTONE & MARR, LTD., 105 WEST ADAMS STREET, SUITE 3600, CHICAGO, IL, 60603, US

(21) Appl. No.: 10/785,646

(22) Filed: Feb. 24, 2004

(30) Foreign Application Priority Data
Feb. 26, 2003 (NZ) 524439

(51) Int. Cl. A62B 18/02; A62B 18/08

(52) U.S. Cl. 128/206.21; 128/206.24; 128/207.11

(57) ABSTRACT

A patient interface for delivering pressurised gases to a user comprising a housing configured to receive gases and deliver them to a user and a forehead rest. The forehead rest is engaged with the housing and has a single area of contact with a user's forehead. The forehead rest includes a bridge portion between the user's forehead and housing allowing a substantially unrestricted view for a user's eyes. The forehead rest is pivotally movable in relation to the housing and can be locked by a friction engagement into position.

### FIELD OF INVENTION

This invention relates to patient interfaces particularly though not solely for use in delivering CPAP therapy to patients suffering from obstructive sleep apnoea (OSA).

### BACKGROUND OF THE INVENTION

In the art of respiration devices, a variety of respiratory masks are well known that cover the nose and/or mouth of a human user in order to provide a continuous seal around the nasal and/or oral areas of the face, such that gas may be provided at positive pressure within the mask for consumption by the user. The uses for such masks range from high altitude breathing (i.e., aviation applications) to mining and fire fighting applications, to various medical diagnostic and therapeutic applications.

One requisite of such respiratory masks has been that they provide an effective seal against the user's face to prevent leakage of the gas being supplied. Commonly, in prior mask configurations, a good mask-to-face seal has been attained in many instances only with considerable discomfort for the user. This problem is most crucial in those applications, especially medical applications, which require the user to wear such a mask continuously for hours or perhaps even days. In such situations, the user will not tolerate the mask for long durations and optimum therapeutic or diagnostic objectives will not be achieved, or will be achieved with great difficulty and considerable user discomfort.

U.S. Pat. No. 5,243,971 and U.S. Pat. No. 6,112,746 are examples of prior art attempts to improve the mask system. U.S. Pat. No. 5,570,689, PCT publication No. WO 00/78384 and U.S. Pat. No. 6,119,693 are examples of attempts to improve a forehead rest attached to the mask.

### SUMMARY OF THE INVENTION

It is an object of the present invention to attempt to provide a patient interface which goes some way to overcoming the abovementioned disadvantages in the prior art or which will at least provide the industry with a useful choice.

In a first aspect the present invention consist in an interface for delivering pressurised gases to a user comprising:

a housing configured to receive gases and deliver them to a user,

a forehead rest engaged with said housing and having a single area of contact with a user's forehead and including a bridge member between a users forehead and said housing allowing a substantially unrestricted view for a users eyes.

Preferably said bridge member is adjustable or configurable in orientation with respect to said housing.

Preferably said bridge member includes a pivoting engagement to said housing.

Preferably said bridge member has a substantially parallel side.

Preferably said forehead rest including attachment points for headgear, said attachment points lying in an approximately mid sagittal plane.

Preferably said interface is a mask.

Preferably said mask is a nasal mask.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF DESCRIPTION OF THE DRAWINGS

Preferred forms of the present invention will now be described with reference to the accompanying drawings.

FIG. 1 is a block diagram of a humidified continuous positive airway pressure (system) as might be used in conjunction with the present invention

FIG. 2 is an illustration of the nasal mask in use according to the preferred embodiment of the present invention.

FIG. 3 shows a perspective view of the mask with cushion

FIG. 4 is a cutaway view of the mask showing the cushion.

FIG. 5 is a cutaway view of the periphery of the outer membrane of the mask cushion.

FIG. 6 is a cutaway view of the periphery of the mask body portion.

FIG. 7 is a perspective view of the narrow forehead rest.

FIG. 8 is a front view of the narrow forehead rest of FIG. 7.

FIG. 9 shows a prior art forehead rest in isolation.

FIG. 10 shows a section view of a forehead rest cushion that maybe used with the mask and forehead rest of the present invention.

FIG. 11 is a section of an alternative forehead rest cushion.

FIG. 12 is a cross section view of Se friction engagement that is used to fix the forehead rest in position.

### DETAILED DESCRIPTION

The present invention provides improvements in the delivery of CAP therapy. In particular a patient interface is described which is quieter for the user to wear and reduces the side leakage as compared with the prior art. It will be appreciated that the patient interface as described in the preferred embodiment of the present invention can be used in respiratory care generally or with a ventilator but will now be described below with reference to use in a humidified CAP system. It will also be appreciated that the present invention can be applied to any form of patient interface including, but not limited to, nasal masks, oral masks and mouthpieces.

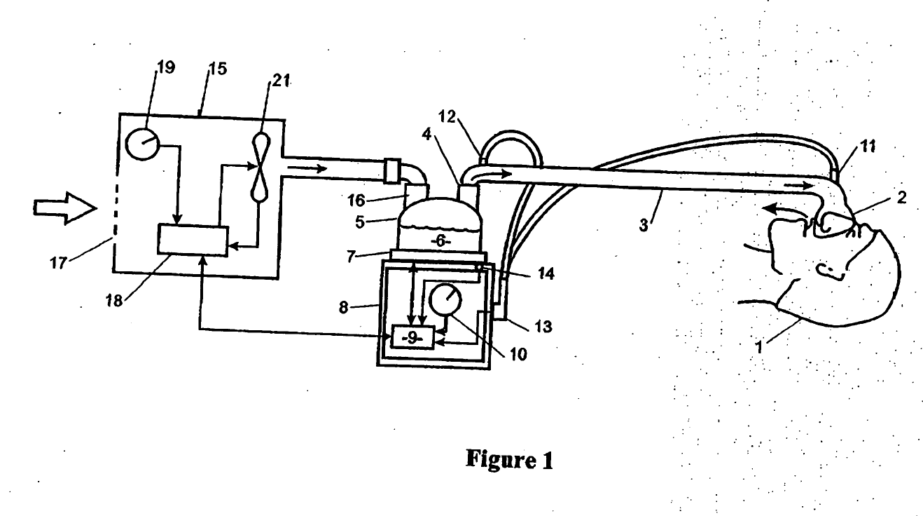

With reference to FIG. 1 a humidified Continuous Positive Airway Pressure (CPAP) system is shown in which a patient 1 is receiving humidified and pressurised gases through a patient interface 2 connected to a humidified gases transportation pathway or inspiratory conduit 3. It should be understood that delivery systems could also be VPAP (Variable Positive Airway Pressure) and BiPAP (Bi-level Positive Airway Pressure) or numerous other forms of respiratory therapy. Inspiratory conduit 3 is connected to the outlet 4 of a humidification chamber 5 that contains a volume of water 6. Inspiratory conduit 3 may contain heating means or heater wires (not shown) which heat the walls of the conduit to reduce condensation of humidified gases within the conduit. Humidification chamber 6 is preferably formed from a plastics material and may have a highly heat conductive base (for example an aluminium base) which is in direct contact with a heater plate 7 of humidifier 8. Humidifier 8 is provided with control means or electronic controller 9 that may comprise a microprocessor based controller executing computer software commands stored in associated memory.

Controller 9 receives input from sources such as user input meads or dial 10 through which a user of the device may, for example, set a predetermined required value (preset value) of humidity or temperature of the gases supplied to patient 1. The controller may also receive input from other sources; for example, temperature and/or flow velocity sensors 11 and 12 through connector 13 and heater plate temperature sensor 14. In response to the user set humidity or temperature value input via dial 10 and the other inputs, controller 9 determines when (or to what level) to energise heater plate 7 to heat the water 6 within humidification chamber 5. A flow of gases (for example air) is provided to the chamber through inlet 16 from a gases supply means or blower 15. As the volume of water 6 within humidification chamber 5 is heated, water vapour begins to fill the volume of the chamber above the water's surface and is passed out of the humidification chamber 5 through outlet 4. Exhaled gases from the patient's mouth are passed directly to ambient surrounding in FIG 1.

Blower 15 is provided with variable pressure regulating means or variable speed fan 21 which draws air or other gases through blower inlet 17. The speed of variable sped fan 21 is controlled by electronic controller 18 (or alternatively the function of controller 18 could carried out by controller 9) in response to inputs from controller 9 and a user set predetermined required value (preset value) of pressure or fan speed via dial 19.

Nasal Mask

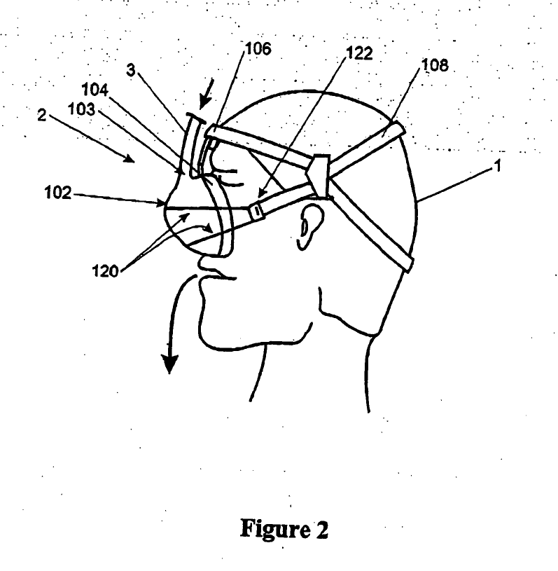

According to a first embodiment of the present invention the patient interface is shown in FIG. 2 as a nasal mask. The mask includes a hollow body 102 with an inlet 103 connected to the inspiratory conduit 3. The mask 2 is positioned around the nose of the user 1 with the headgear 108 secured around the back of the head of the patient 1. The restraining force from the headgear 108 on the hollow body 102 and the forehead rest 106 ensures enough compressive force on the mask cushion 104, to provide an effective seal against the patient's face.

The headgear 108 maybe attached by a clip 122 to sliding straps 120 that allow movement of the headgear 108 but prevent the mask 2 from moving on the patients face.

The hollow body 102 is constructed of a relatively inflexible material for example, polycarbonate plastic. Such a material would provide the requisite rigidity as well as being transparent and a relatively good insulator. The expiratory gases can be expelled through a valve (not shown) in the mask, a further expiratory conduit (not shown), or any other such method as is known in the art.

Mask Cushion

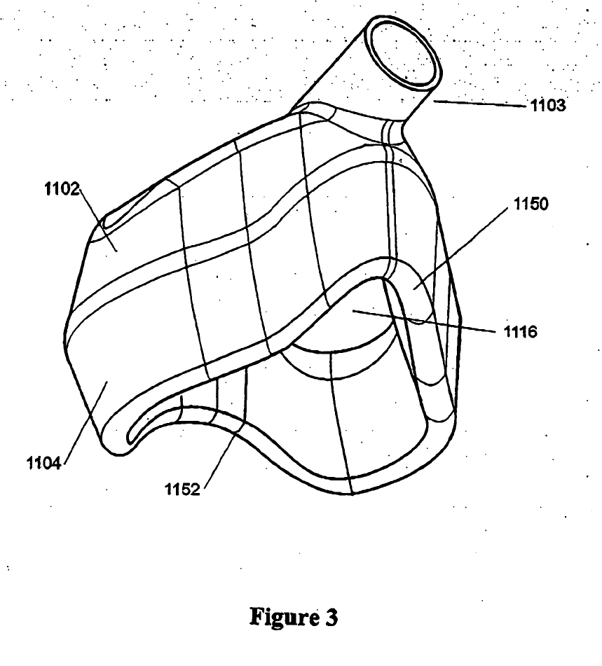

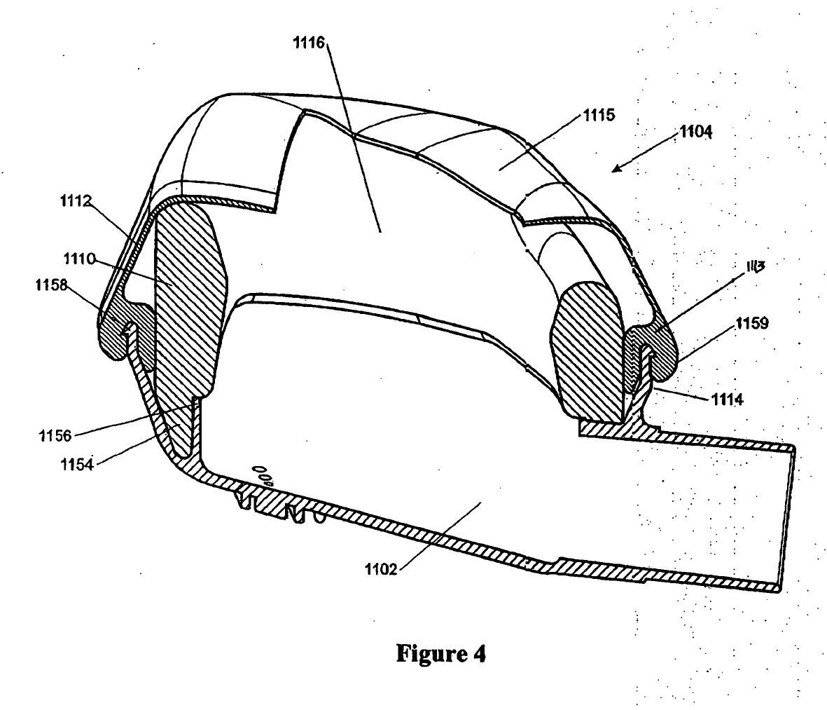

Referring now to FIGS. 3 and 4, the mask cushion 1104 is provided around the periphery of the nasal mask 1102 (having a bridge member attachment 1103) to provide an effective seal onto the face of the user to prevent leakage. The mask cushion 1104 is shaped to approximately follow the contours of a patient's face. The mask cushion 1104 will deform when pressure is applied by the headgear (108, as shown in FIG. 2), to adapt to the individual contours of any particular user. In particular, there is an indented section 1150 intended to fit over the bridge of the user's nose as well as a less indented section 1152 to seal around the section beneath the nose and above the upper lip.

In FIG. 4 we see that the mask cushion 1104 is composed of an inner foam cushion 1110 covered by an outer sealing sheath 1112. The inner cushion 1110 is constructed of a resilient material for example polyurethane foam, to distribute the pressure evenly along the seal around the user's face. The inner cushion 1110 is located around the outer periphery 1114 of the open face 1116 of the hollow body 1102 Similarly the outer sheath 1112 may be commonly attached at its base 1113 to the periphery 1114 and loosely covers over the top of the inner cushion 1110.

In the preferred embodiment shown in FIGS. 3 to 6 the bottom of the inner cushion 1110 fits into a generally triangular cavity 1154 in the hollow body 1102. The cavity 1154 is formed from a flange 1156 running mid-way around the interior of the hollow body.

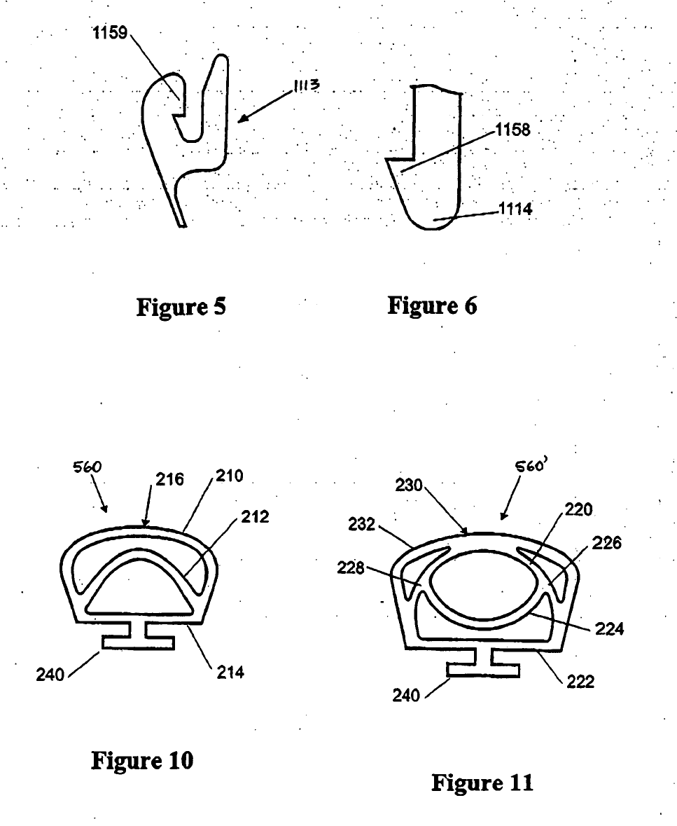

The outer sheath 1112 fits in place over the cushion 1101 holding it in place. The sheath 1112 is secured by a snap-fit to the periphery 1114 of the hollow body. In FIGS. 5 and 6 the periphery 1114 is shown including an outer bead 1158. The sheath 1112 includes a matching bead 1159, whereby once stretched around the periphery the two beads engage to hold the sheath in place.

Prior Art Forehead Rest

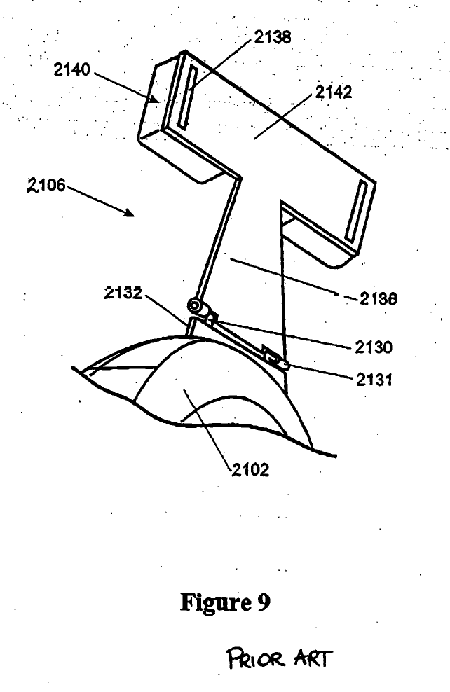

A prior art nasal mask 2102 is shown in FIG. 9. This mask 2102 includes a hinged forehead rest 2106. The attachment of the forehead rest 2106 to the mask body 2102 effectively allows the forehead rest 2106 to move freely in proximity to the user but with no lateral movement. Pins 2130 are provided mounted on a base 2132 attached to the mask body 2102. These pins 2130 are co-axial within cylinders 2131 mounted on a bridge member 2136. The forehead rest 2106 is T-shaped.

At the top end 2142 (that rests against the user's forehead) of the bridge member 2136, harnessing slots 2138 are provided which allow straps from the headgear to be inserted to secure the mask to the headgear. For the uses comfort one or more resilient cushions 2140 are provided underneath the top end 2142 of the bridge member 2136, which rest on the forehead of the user. The cushion 2140 might be constructed of silicon or any foam materials as is known in the art for providing cushioning.

The forehead rest 2106 may include a weakened section 2130 at its base 2132 which allows the joining member 2136 to pivot from the mask body 2102. The bridge member extends up to the forehead of the user. The mask can also include a vertical upwardly extending inlet. In this case the bridge member 2136 is hinged at its base 2132 to either side of the inlet passage, Again the bridge member would then extend to the forehead.

Narrow Forehead Rest

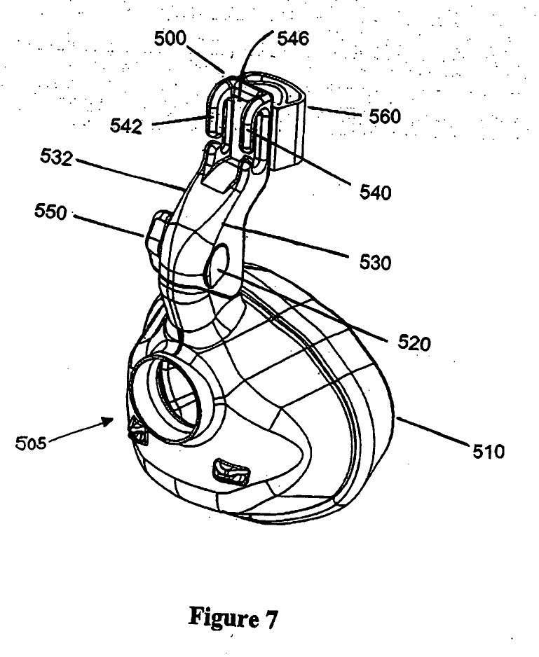

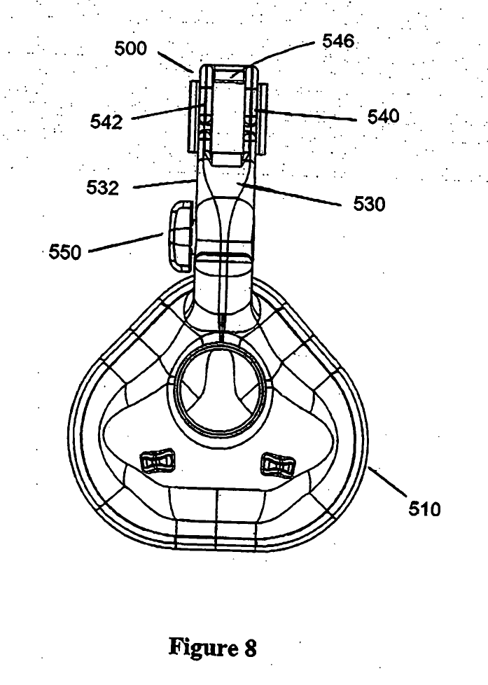

In FIGS. 7 and 8, a nasal mask 505 is shown with the forehead support 500 of the present invention. In this embodiment the forehead rest 500 is narrow to minimise the profile and frontal appearance of the mask 505.

The forehead rest 500 is comprised of a bridge member 532 that is narrow with parallel sides. The bridge member 532 has an adjustment knob 550 placed on the opposite side of a friction member 520. When the adjustment knob 550 is a loosened the position of the bridge member 530 can be adjusted to any desired angle relative to the mask body 510, in a similar to the prior art mask of FIG. 9. The bridge member 532 may also be fixed in place or include a malleable inset to allow the bridge member 532 to flex. A single cushion 560 is attached to the apex 546 of the bridge member 532. Headgear (not shown) attaches through slots 540, 542 which extend away from the forehead in an approximately mid sagittal plane.

The forehead rest is most preferably made from a thermoplastic polycarbonate or similar and manufactured by injection moulded. The advantage is that the forehead sport is small and streamlined as the headgear attachment points are placed above the main forehead support structure, rather than extending out the side, which is the traditional approach as shown in FIG. 9. A mask is smaller and therefore is less intrusive than prior art masks with T-shaped forehead rests.

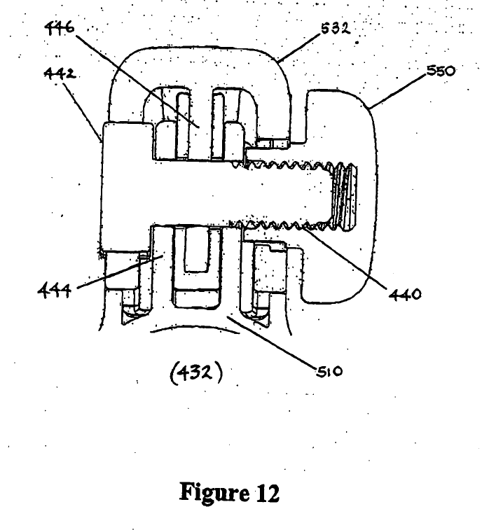

The adjustment knob 550 in a loosened position the bridge member 532 maybe pivoted to any desired angle with respect to the mask body 434. The locking of the bridge member 532 in a particular position is performed by a friction engagement 432 with the mask body 510 as shown in FIG. 12. Once in the desired position the knob 550 may be configured to a tightened position whereby the angle of the bridge member 532 relative to the mask body 510 is substantially fixed by virtue of the friction engagement in the interlocking parts.

The adjustment knob 550 includes a helical thread engaging with a reciprocal helical thread 440 on pin 442 running transversely through the bridge member 532. The pin also runs through apertures in flanges 444 extending up from the mask body 510 and an internal flange from 446. In this fashion the flanges 444 and 446 may frictionally engage (optionally also with the inner surfaces of the bridge member 532) once the knob 550 is in a tightened position. Adjustment may either be allowed in a finite number of predetermined positions or may be completely variable.

The forehead rest of the present invention may be locked in a single position. The locking action may be provided by an engaging clip that is attached through an aperture at the base of a bridge member, similar to that disclosed in co-pending U.S. patent application Ser. No. 10/297279 or copending U.S. patent application Ser. No. 10/267279. The lock and clip may have number of ribs that engage with at least two ribs on the interior of the aperture that allows it to lock and place it in at least an upper Position and a lower position. In the upper position the locking clip is clear of the mask body and allows the bridge member to pivot freely. In the lower position the locking pin engages with a cavity on the surface of the said mask body which locks said bridge member at a predetermined angular position with respect to said mask body.

Furthermore in other embodiments the forehead rest may have a spring-loaded attachment to the mask body. The force provided by the spring is adjusted to give an optimum pressure on the bridge of the use's nose. This ensures adequate sealing around the nose and prevents any excess pressure causing irritation. The spring comprises a spirally wound spring attached at one end to the mask body, and at the other to the base of the bridge member The spring is biased to provide a clockwise moment.

In a further embodiment the forehead rest may have a malleable insert. The malleable insert would comprise a metal strip joining the mask body to the forehead rest. The metal can be chosen from anyone of a number of metals known in the art to provide enough malleability to be bent to a particular angle and enough stiffness to retain the angle once installed on the patient. The malleable member may be connected to the mask body by any type of mounting.

In a still further embodiment the forehead rest of the present invention may be provided with a pivoting bridge member and an adjustable pivot stop as described in co-pending U.S. patent application Ser. No. 10/297279. The bridge member is attached to and pivots about pins extending from in the side of the upwardly extending inlet conduit of the mack. The pine engage with matching apertures in the bridge member.

The pivot stop may be adjusted into a number of predetermined positions whereby the angle to which the forehead rest member can freely pivot is restricted. Accordingly the pivot stop requires an adjustable engagement with the bridge member. Preferably the engagement is provided with a locking clip which engages with any one of a number of mating depressions or protrusions in the bridge member. Alternatively the engagement could be provided by for example a friction engagement including some tensioned member (not shown) frictionally engaging the bridge member. The tensioned member could be releasable to allow movement and engageable to fix the position.

Forehead Rest Cushion

Referring to FIG. 10 one embodiment of the forehead rest cushion 560 that maybe used with the forehead rest of the present invention is illustrated. The cushion 560 in cross section generally includes a first convex member 210 and a second inner convex member 212 both of which are attached at each end to a straight base member 214. The inner convex member 212 is a substantially flatter convex shape than the first convex member 210. In this fashion when the cushion 560 comes into contact with the user's face the first convex member 210 deforms as more pressure is applied to the cushion towards the face. This is a first mode of deformation. Once the first convex member 21 deforms enough to contact the second convex member a second mode of deformation occurs. As will be appreciated, as the first convex member is less flat than the second convex member 212 the first mode requires less force. Once in the second mode of deformation extra force is required to deform the first convex member 210 and the second convex member 212 as well as the fact that a flatter convex shape requires more force to deform. This configuration described above results in more even deformation force across the load beating surface 216 of the cushion and also results in a more distributed force of cushioning when the cushion 560 is deformed.

An alternative cushion 560′ that may be used with the mask and forehead rest of the present invention is shown in FIG. 13. The cushion 560′ is shown with a first convex member 220 attached at either end to a straight base member 222. A second convex member 224 is inverted with respect the first convex member 220 and is attached at either end two points on the 226,228 on the first convex member 220. The second convex member is lower in overall height than the first convex member 220 such that a first mode of deformation occurs when the first convex member 220 is deformed. A second mode of deformation occurs when the second convex member 224 contacts the base member 222. The first convex member 220 and the second convex member 224 deform simultaneously. The forces across the load bearing surface 230 are further distributed by virtue of a generally quadrilateral member 232 including as one side the base member 222 which attaches over the first convex member 220 approximately at its ends and at its load bearing point 234. The quadrilateral member 232 provides additional stiffness and reduces lateral deformation.

We claim:

1. An interface for delivering pressurised gases to a user comprising:
a housing configured to receive gases and deliver them to a user,
a forehead rest engaged with said housing and having a single area of contact with a user's forehead and including a bridge member between a users forehead and said housing allowing a substantially unrestricted view for a users eyes.

2. A interface for delivering pressurised gases to a user according to claim 1 wherein said bridge member is adjustable or configurable in orientation with respect to said housing.

3. An interface for delivering pressurised gases to a user according to claim 1 wherein said bridge member includes a pivoting engagement to said housing.

4. An interface for delivering pressurised gases to a user according to claim 1 wherein said bridge member has a substantially parallel side.

5. An interface for delivering pressurised gases to a user according to claim 1 wherein said forehead rest includes attachment points for headgear, said attachment points lying in an approximately mid sagittal plane.

6. An interface for delivering pressurised gases to a user according to claim 1 wherein said interface is a mask.

7. An interface for delivering pressurised gases to a user according to claim 6 wherein said mask is a nasal mask.
